(19) United States
(12) Patent Application Publication
(10) Pub. No.: US 2008/0189340 A1
(43) Pub. Date: Aug. 7, 2008

(54) APPARATUS, SYSTEM, AND METHOD FOR SYNCHRONIZING A REMOTE DATABASE

(76) Inventors: David Randall Blea, Tucson, AZ (US); Errol Jay Calder, Vail, AZ (US); Gregory Edward McBride, Vail, AZ (US); Todd Benjamin Schlomer, Tucson, AZ (US); John Jay Wolfgang, Midlothian, AZ (US)

Correspondence Address: Brian C. Kunzler;Kunzler and Associates, Suite 600, 8 East Broadway, Salt Lake City, UT, 84111, US

(21) Appl. No.: 11/670,321

(22) Filed: Feb. 1, 2007

(51) Int. Cl. G06F 17/30

(52) U.S. Cl. 707/204; 707/E17.005

(57) ABSTRACT

An apparatus, system, and method are disclosed for synchronizing a remote database. A monitor module monitors an update from a database application to a primary table of a primary database. The update is communicated through an application server. The application server is configured to manage access to the primary database by the database application. A construction module constructs a SQL command in text format that is equivalent to the update. An update module applies the SQL command to a backup table of a backup database. The backup table is a logical mirror image of the primary table prior to the application of the update to the primary table. In one embodiment, a verification module verifies that the SQL command is successfully applied to the backup table.

### CROSS REFERENCE TO RELATED APPLICATIONS

The subject matter of this application is related to a United States Patent Application entitled “APPARATUS, SYSTEM, AND METHOD FOR INITIALIZING A SYNCHRONIZED REMOTE DATABASE” filed on Feb. 1, 1007 for David R. Blea et al. as attorney docket number TUC920060097US1.

### BACKGROUND OF THE INVENTION

1. Field of the Invention

This invention relates to backing up a database and more particularly relates to synchronizing a remote backup database.

2. Description of the Related Art

Enterprise data processing systems often support database applications that store valuable information such as transaction data, customer information, inventory data, product data, financial data, and the like in databases. An enterprise data processing system may employ an application server to store databases and to provide access to the databases for database applications.

For example, a database application may retrieve data from a database through an application server. Similar, the database application may store data to vend the database through the application server. The application server may also be configured to manage and maintain the database.

The data stored in databases is often very valuable. As a result, a database is typically backed up or copied to a backup copy to protect its data from loss. Backup copies are often stored in separate data processing systems and even in remote locations so that if a primary location is damaged, a backup copy at a remote location will still preserve the data.

A backup copy is only consistent with original database at the point in time the backup copy is created. Subsequent updates, additions, and modifications to the original database are not included in the backup copy and so are in danger of being lost if the original database is lost. As a result, backup databases are often synchronized with original databases. Original databases are referred to herein as primary databases.

Unfortunately, because the primary database must use operational bandwidth to synchronize the backup database with the primary database, synchronizing the backup database can degrade the performance of the primary database. In addition, the primary database may only be capable of creating backup databases of the same type as the primary database, precluding backing up primary databases to other types of databases.

### SUMMARY OF THE INVENTION

From the foregoing discussion, there is a need for an apparatus, system, and method that synchronize a remote backup database with a primary database. Beneficially, such an apparatus, system, and method would synchronize the backup database without degrading the performance of the primary database.

The present invention has been developed in response to the present state of the art, and in particular, in response to the problems and needs in the art that have not yet been fully solved by currently available database synchronization methods. Accordingly, the present invention has been developed to provide an apparatus, system, and method for synchronizing a remote backup database that overcome many or all of the above-discussed shortcomings in the art.

The apparatus to synchronize a remote database is provided with a plurality of modules configured to functionally execute the steps of monitoring an update from a database application, constructing a Structured Query Language (SQL) command equivalent to the update, and applying the SQL command to a backup table. These modules in the described embodiments include a monitor module, a construction module, and an update module. The apparatus may also include a verification module and an error mitigation module.

The monitor module monitors an update from a database application to a primary table of a primary database. The update is communicated through an application server. The application server is configured to manage access to the primary database by the database application.

The construction module constructs a SQL command in text format that is equivalent to the update. The update module applies the SQL command to a backup table of a backup database. The backup table is a logical mirror image of the primary table prior to the application of the update to the primary table.

In one embodiment, the verification module verifies that the SQL command is successfully applied to the backup table. The error mitigation module may mitigate an unsuccessful application of the SQL command to the backup table. The apparatus synchronizes the remote backup database with the primary database.

A system of the present invention is also presented to synchronize a remote database. The system may be embodied in one or more data processing systems. In particular, the system, in one embodiment, includes a primary data processing system and a remote data processing system.

The primary data processing system includes an application server and a database application. The application server manages access to a primary database. The database application accesses the primary database through the application server.

The application server includes a monitor module and a construction module. The monitor module monitors an update from the database application to a primary table of the primary database. The update is communicated through the application server. The construction module constructs a SQL command in text format that is equivalent to the update.

The remote data processing system includes an update module and a verification module. The update module applies the SQL command to a backup table of a backup database. The backup table is a logical mirror image of the primary table prior to the application of the update to the primary table. The verification module verifies that the SQL command is successfully applied to the backup table. The system synchronizes the backup table with the primary table transparently to the database.

A method of the present invention is also presented for synchronizing a remote database. The method in the disclosed embodiments substantially includes the steps to carry out the functions presented above with respect to the operation of the described apparatus and system. In one embodiment, the method includes monitoring an update from a database application, constructing a SQL command equivalent to the update, and applying the SQL command to a backup table.

A monitor module monitors an update from a database application to a primary table of a primary database. The update is communicated through an application server. The application server is configured to manage access to the primary database by the database application.

A construction module constructs a SQL command in text format that is equivalent to the update. An update module applies the SQL command to a backup table of a backup database. The backup table is a logical mirror image of the primary table prior to the application of the update to the primary table.

In one embodiment, a verification module verifies that the SQL command is successfully applied to the backup table. An error mitigation module may mitigate an unsuccessful application of the SQL command to the backup table. The method synchronizes the remote backup database with the primary database from the monitored update.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The embodiment of the present invention synchronizes a remote backup database with a primary database by monitoring an update to the primary database, constructing an SQL statement from the update, and applying the SQL statement to the backup database. The present invention synchronizes the backup database autonomously from the primary database. In addition, the present invention allows a backup database of one type to be synchronized with a primary database of another type.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of data processing systems in accordance with the present invention;

FIG. 2 is a schematic block diagram illustrating one embodiment of an application server system of the present invention;

FIG. 3 is a schematic block diagram illustrating one embodiment of a database of the present invention;

FIG. 4 is a schematic block diagram illustrating one embodiment of a table of the present invention;

FIG. 5 is a schematic block diagram illustrating one embodiment of primary and backup databases of the present invention;

FIG. 6 is a schematic block diagram illustrating one embodiment of a synchronization apparatus of the present invention;

FIG. 7 is a schematic flow chart diagram illustrating one embodiment of a synchronization method of the present invention; and

FIG. 8 is a schematic block diagram illustrating one embodiment of a synchronization process of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

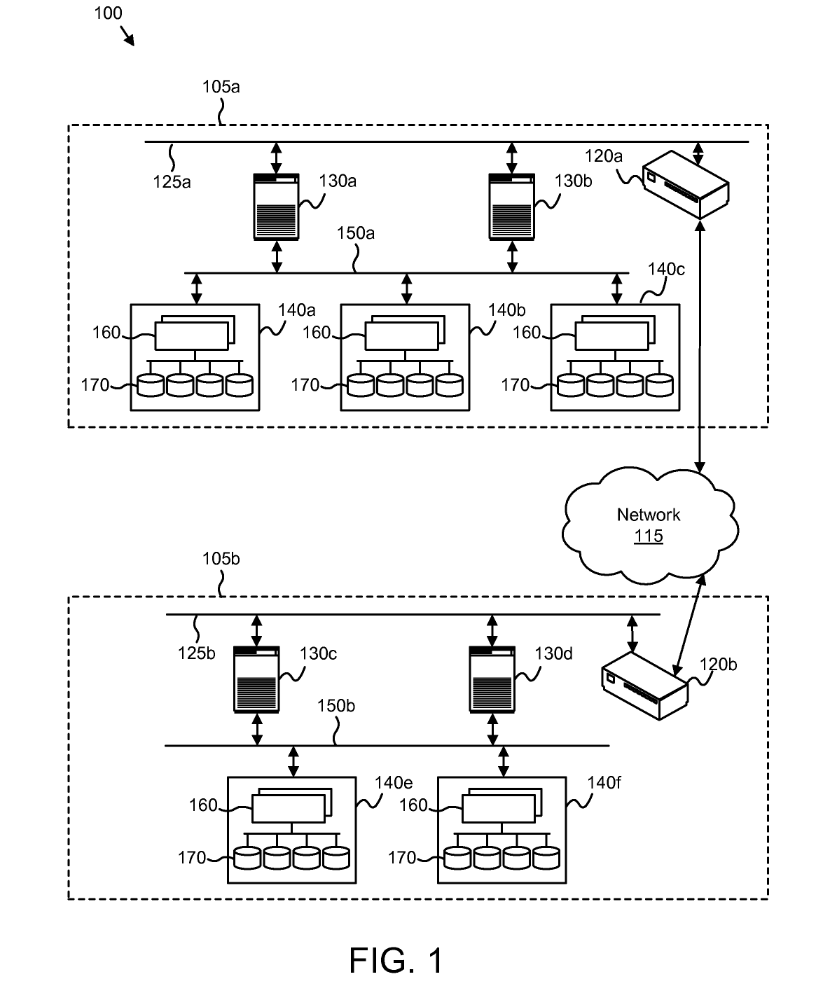

FIG. 1 is a schematic block diagram illustrating one embodiment of data processing systems 100 in accordance with the present invention. Each data processing system 105 is shown with one or more servers 130, an internal network 125, a communications channel 150, and one or more storage subsystems 140. Each storage subsystem 140 includes one or more storage controllers 160 and one or more storage devices 170.

The storage devices 170 may store data for the servers 130. The storage controllers 160 may manage the storage devices 170, writing data to and reading data from the storage devices 170. The servers 130 may execute one or more application server software programs. The application server software programs are referred to herein as application servers. The application servers may manage access to the data stored on the storage devices 170.

The data processing systems 105 are shown in communication through through a network 115. The network 115 may be the Internet, a private wide area network, or the like. In one embodiment, each data processing system communicates with the network 115 through a router 120. The servers 130 may communicate with the network 115 through the internal network 125 and the router 120. For example, a first server 130a of a first data processing system 105a may communicate with a third server 130c of a second data processing system 105b through a first internal network 125a, a first router 120a, the network 115, a second router 120b, and a second internal network 125b.

Hereinafter the first data processing system 105a is referred to as a primary data processing system 105a. In one embodiment, data that is to be backed up may originate on the primary data processing system. The second data processing system 105b is referred to as a remote data processing system 105b. The remote data processing system 105b may back up the data from the primary data processing system 105a. In particular, the present invention synchronizes data stored on the remote data processing system 105b with data of the primary data processing system 105a.

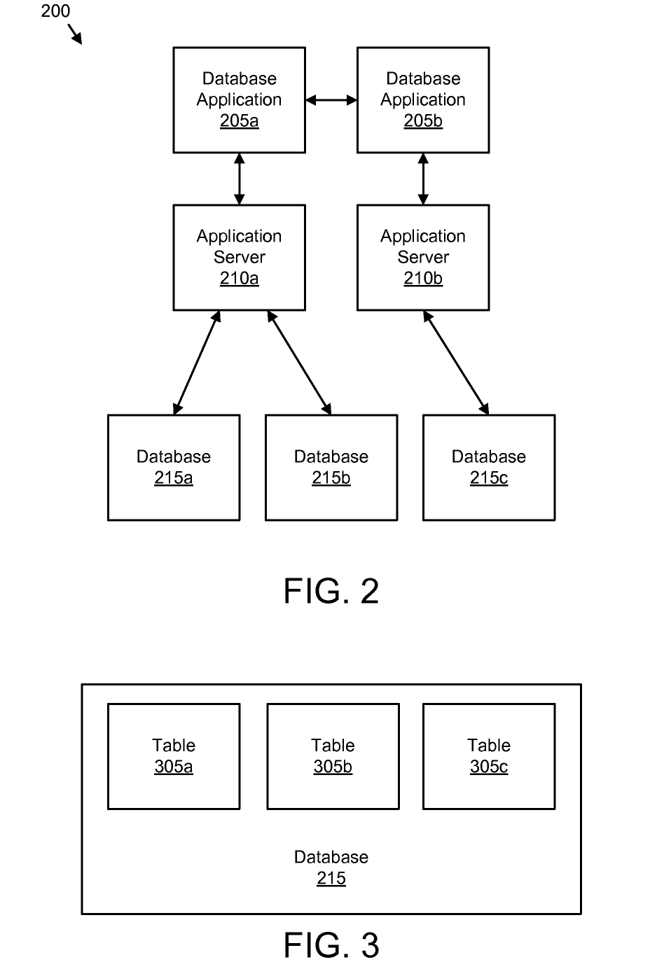

FIG. 2 is a schematic block diagram illustrating one embodiment of an application server system 200 of the present invention. The description of the system 200 refers to elements of FIG. 1, like numbers referring to like elements. The system 200 includes one or more database applications 205, one or more application servers 210, and one or more databases 215. For simplicity two database applications 205, two application servers 210, and three databases 215 are shown, although any number of database applications 205, application servers 210, and databases 215 may be employed.

In one embodiment, the application servers 210 comprise IBM Websphere Software produced by International Business Machines Corporation (IBM) of Armonk, N.Y. The databases 215 may be stored on the storage devices 170. The application servers 210 may be configured as one or more computer program products comprising a computer useable medium and each having a computer readable program. The computer readable programs may execute on the servers 130. The database applications 205 may also comprise computer program products that execute on the servers 130. Alternatively, the database applications 205 may execute on a remote device.

The database applications 205 are configured to store data in the databases 215 and manipulate the data. For example, a database application 205 may store customer data in a database 215. In addition, the database application 205 may generate invoices from the customer information for delivery to customers.

The application servers 210 manage access to the databases 215. Thus a database application 205 may store data to a database 215 by communicating the data to the application server 210. The application server 210 applies the data to the database 215. In one embodiment, the database application 205 can only access the database 215 through the application server 210.

FIG. 3 is a schematic block diagram illustrating one embodiment of a database 215 of the present invention. The database 215 is the database of FIG. 2. The description of the database 215 refers to elements of FIGS. 1-2, like numbers referring to like elements. The database 215 includes one or more tables 305 as is well known to those of skill in the art. Each table 305 may include data with a specific organization as will be described hereafter.

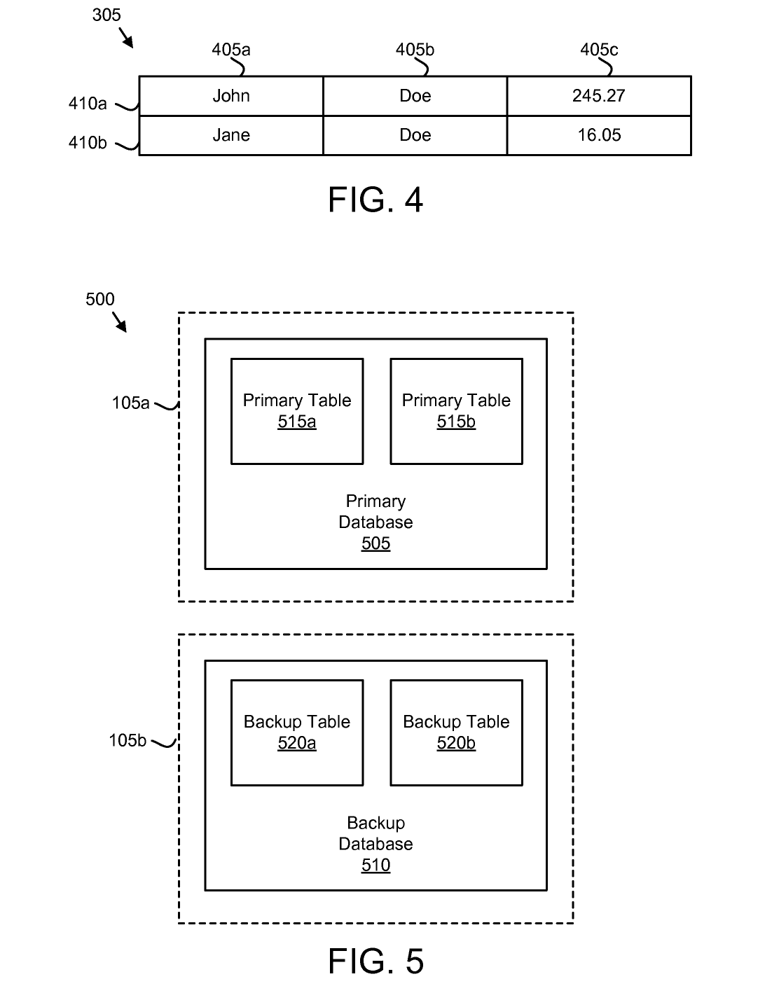

FIG. 4 is a schematic block diagram illustrating one embodiment of a table 305 of the present invention. The table 305 is the table 305 of FIG. 3. As shown, the table 305 includes one or more columns 405 and one or more rows 41 0. The description of the table 305 refers to elements of FIGS. 1-3, like numbers referring to like elements.

The table 305 may comprise a schema defining the columns 405. Each column 405 may specify a type of data such as integer data, string data, logical data, real number data, and the like for a column 405. In the depicted example, a schema may specify that the table 305 includes a first string column 405a for a first name, a second string column 405b for a last name, and real number column 405c for an account balance.

Each row 410 contains a data field for each column 405. Continuing the depicted example with exemplary data, a first row 410a may store the name ‘John’ in the first name string column 405a, the name ‘Doe’ in the last name string column 405b, and the number ‘245.27’ in the account real number column 405c. Similarly, a second row 410b may store the name ‘Jane’ in the first name string column 405a, the name ‘Doe’ in the last name string column 405b, and the number ‘16.05’ in the account real number column 405c.

In one embodiment, rows 410 may be dynamically added and deleted from the table 305. In addition, the data stored in the data field columns 405 of a row may be modified. For example, the number in the account real number column 405c of the second row 410b may be modified to ‘21.96.’

FIG. 5 is a schematic block diagram illustrating one embodiment of primary and backup databases 500 of the present invention. The databases 500 may be the databases 215 of FIG. 2. The description of the databases 500 refers to elements of FIGS. 1-4, like numbers referring to like elements. The databases 500 include a primary database 505 and a backup database 510. The primary database 505 may be used to store active data such as transaction data, customer data, financial data, and the like.

The backup database 510 may be configured to mirror the primary database 505, so that another instance of the primary database 505 is available in case the primary database 505 becomes corrupted, damaged, inaccessible, or the like. As used herein, mirroring refers to maintaining an equivalent copy. For example, the backup database 510 may store substantially the same data in substantially the same organization as the primary database 505. The primary database 505 and the backup database 510 need not be the same type of database. For example, the primary database 505 may be organized as a DB2 Universal Database as provided by IBM while the backup database 510 may be organized as an Oracle Database 10 g database as provided by Oracle Corporation of San Mateo, Calif.

By mirroring the primary database 505, the backup database 510 protects the data of the primary database 505. For example, if the primary database 505 becomes inoperable, the backup database 510 may be used in place of the primary database 505 as is well known to those of skill in the art.

The primary database 505 is stored on the primary data processing system 105a. The backup database 510 is stored on the remote data processing system 105b. For example, the primary database 505 may be stored on storage devices 170 of the primary data processing system 105a while the backup database 510 may be stored on storage devices 170 of the remote data processing system 105b. Although for simplicity only one primary database 505 and one backup database 510 are shown, any number of primary databases 505 and backup databases 510 may be employed.

The primary database 505 and backup database 510 may be organized with tables 305 such as are described for the database 215 of FIG. 3. The primary database 505 includes one or more primary tables 515. Similarly, the backup database 510 includes one or more backup tables 520. The primary tables 515 and the backup tables 520 may be organized with columns 405 and rows 410 as described in FIG. 4.

In one embodiment, selected primary tables 515 are mirrored with backup tables 520 at the backup database 510. For example, a first primary table 515a may store customer data while a second primary table 515b may store transaction data. A first backup table 520a may mirror the customer data of the first primary table 515a while a second backup table 520b may mirror the transaction data of the second primary table 515b.

Although the present invention may synchronize any number of backup tables 520 with any number of primary tables 515, for simplicity the synchronizing of one first backup table 520a with one primary table 515 will be described. One of skill in the art will recognize that the present invention may synchronize any number of backup tables 520 residing in any number of backup databases 510 on any number of remote data processing systems 105b.

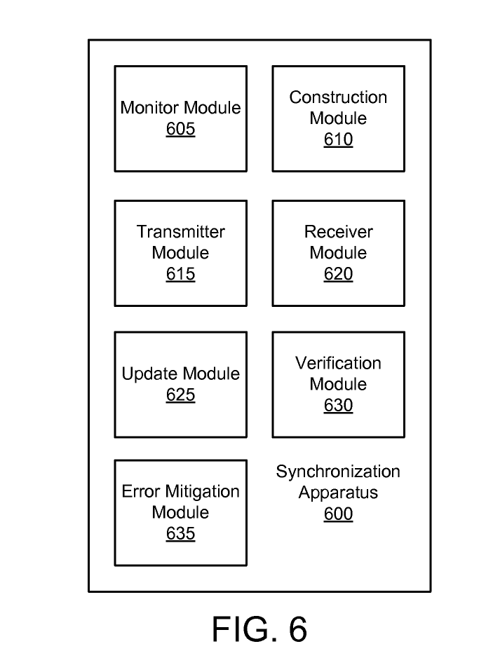

FIG. 6 is a schematic block diagram illustrating one embodiment of a synchronization apparatus 600 of the present invention. The apparatus 600 synchronizes the backup database 510 with the primary database 505. The description of the apparatus 600 refers to elements of FIGS. 1-5, like numbers referring to like elements.

The apparatus 600 includes a monitor module 605, construction module 610, transmitter module 615, receiver module 620, update module 625, verification module 630, and error mitigation module 635. The monitor module 605, construction module 610, transmitter module 615, receiver module 620, update CE module 625, verification module 630, and error mitigation module 635 may comprise one or more computer readable programs that execute on the servers 130.

The monitor module 605 monitors an update from a database application 205 to a primary table 515 of the primary database 505. The update is communicated through an application server 210. The application server 210 is configured to manage access to the primary database 505 by the database application 205.

The construction module 610 constructs a SQL command in text format that is equivalent to the update. For example, if the first primary table 515a and the first backup table 520a are each named ‘customer’ and the update is configured to set the account real number column 405c of the second row 410b to the value ‘21.96,’ the construction module 610 may construct the SQL command ‘UPDATE customer SET account=21.96 WHERE index=2;’ to modify the number in the account real number column 405c of the second row 410b of the first backup table 520a to ‘21.96,’ where an index number of the second row 410b is two (2) and ‘account’ is the name of the account real number column 405c.

In one embodiment, the transmitter module 615 transmits the SQL command from the primary data processing system 105a. The transmitter module 615 may include one or more communication protocols, a buffer, and the like that organize the SQL command as a packet and communicate the packet over the first internal network 125a, through the first router 120a, the network 115, the second router 120b, and the second internal network 125b to a server 130 of the remote data processing system 105b.

The receiver module 620 may receive the SQL command at the remote data processing system 105b. In one embodiment, the receive module 620 includes a buffer that stores the packet containing the SQL command and one or more software protocols that parse the SQL command from the packet and route the SQL command to the update module 625

The update module 625 applies the SQL command to the backup table 520 of the backup database 510. Applying the SQL command synchronizes the backup table 520 with the primary table 515.

In one embodiment, the verification module 630 verifies that the SQL command is successfully applied to the backup table 520. The error mitigation module 635 may mitigate an unsuccessful application of the SQL command to the backup table 520. The apparatus 600 synchronizes the backup table 520 of the remote backup database 510 with the primary table 515 of the primary database 505.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

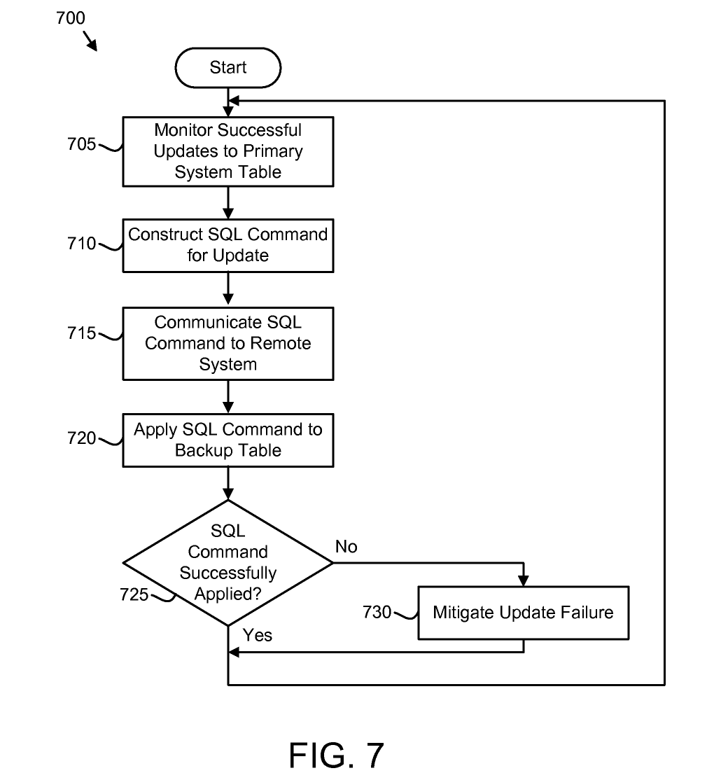

FIG. 7 is a schematic flow chart diagram illustrating one embodiment of a synchronization method 700 of the present invention. The method 700 substantially includes the steps to carry out the functions presented above with respect to the operation of the described apparatus and systems of FIGS. 1-6. In addition, the description of the method 700 refers to elements of FIGS. 1-6, like numbers referring to like elements.

The method 700 begins, and the monitor module 605 monitors 705 an update from a database application 205 through an application server 210 to a primary table 515 of a primary database 505. In one embodiment, the monitor module 605 only monitors 705 successful updates to the primary table 515. For example, if an update is not successfully applied to the primary table 515, the monitor module 605 may disregard the unsuccessful update. Alternatively, the monitor module 605 may only regard an update as the update is successfully applied to the primary table 515. For example, if an update is configured to modify a data field of a row that is locked, the monitor module 605 may only monitor 705 the update when the row is unlocked and the update is successfully applied to the data field.

The construction module 61 0 constructs 71 0 a SQL command in text format that is equivalent to the update. In one embodiment, the update is also configured as an SQL command in text format, so that the SQL command is substantially equivalent to the update. Alternatively, the construction module 61 0 may alter the update to conform to the backup table 520. For example, if the update is the SQL command “INSERT INTO customers (first_name, last_name, account) VALUES (‘Jan’, ‘Roe’, 1.12);” wherein “customers” is the name of primary table 515, first_name is the name of the first name string column 405a, and last_name is the name of the last name string column 405b, the construction module 610 may construct 710 an SQL command “INSERT INTO customers_bak (first_name, last_name, account) VALUES ‘Jan’, ‘Roe’, 1.12);” where “customers_bak” is the name of the backup table 520.

In one embodiment, the construction module 610 aggregates a plurality of SQL commands. The aggregated SQL commands may be communicated to the update module 625 as an update set.

Because the monitor module 605 monitors 705 the update as the update is communicated through the application server 210, the primary database 505 may not be aware that the monitor module 605 monitors 705 the update and the construction module 610 constructs 710 the SQL command. Thus the synchronization method 700 may be autonomous of and transparent to the database 215. As a result, the performance of the primary database 505 is not degraded with synchronizing the backup database 510 and the primary database 505.

In one embodiment, the transmitter module 615 communicates 715 the constructed SQL command to the receiver module 620 of the remote data processing system 105b. Alternatively, the transmitter module 615 communicates the aggregated SQL commands to the receiver module 620. The receiver module 620 may provide the SQL command and/or aggregated SQL commands to the update module 625. Hereinafter, both the SQL command and aggregated SQL commands are referred to as the SQL command.

The update module 625 applies 720 the SQL command to the backup table 520 of the backup database 510. In one embodiment, the update module 625 includes a database application 205. The update module 625 may apply 720 the SQL command using a standard database protocol. In a certain embodiment, the remote data processing system 105b includes an application server 210, and the update module 625 may apply 720 the SQL command through the application server 210.

The backup table 520 mirrors the primary table 515 prior to the application of the update to the primary table 515. The application 720 of the SQL command to the backup table 520 by the update module 625 synchronizes the backup table 520 with the primary table 515. By synchronizing selected primary tables 515 of the primary database 505 with corresponding backup tables 520 of the backup database 510, the method 700 synchronizes the backup database 520 of the remote data processing system 105b.

Because the update module 625 employs SQL commands in text format, the SQL command may be applied 720 to backup tables 520 of types different from the primary table 515. Thus, construction module 610 need not understand all the details of the configuration of the backup table 520. In addition, a plurality of update modules 625 of a plurality of remote data processing systems 105b may each apply the SQL command to backup tables 520 of different types, synchronizing the primary table 515 with backup tables 520 of the different types on different remote data processing systems 105b.

In one embodiment, the verification module 630 verifies 725 that the SQL command is successfully applied to the backup table 520. For example, the verification module 630 may determine that the SQL command is not successfully applied to the backup table 520 if the verification module 630 receives an error message in response to an attempted application of the SQL command. If the verification module 630 verifies 725 that the SQL command is successfully applied, the monitor module 605 continues monitoring 705 updates from the database application 205 to the primary table 515 of the primary database 505.

If the verification module 630 does not verify 725 that SQL command is successfully applied to the backup table 520, the error mitigation module 635 may mitigate 730 the unsuccessful application of the SQL command to the backup table 520. In one embodiment, the error mitigation module 635 may mitigate 730 the unsuccessful application by reapplying the SQL command to the backup table 520.

In an alternate embodiment, the error mitigation module 635 may direct the application server 210 for the primary database 505 to suspend updates to the primary table 520. In addition, the error mitigation module 635 may replicate the entire primary table 515 to the backup table 520. The error mitigation module 635 635 may then direct the application server 210 to resume updates to the primary table 520 and the monitor module 605 may continue monitoring 705 updates from the database application 205 to the primary table 515 of the primary database 505.

In a certain embodiment, error mitigation module 635 may communicate a warning to mitigate 730 the unsuccessful application of the SQL command. For example, the error mitigation module 635 may communicate an error message warning to an administrator. The method 700 synchronizes the remote backup database 520 with the primary database 515 from the monitored update.

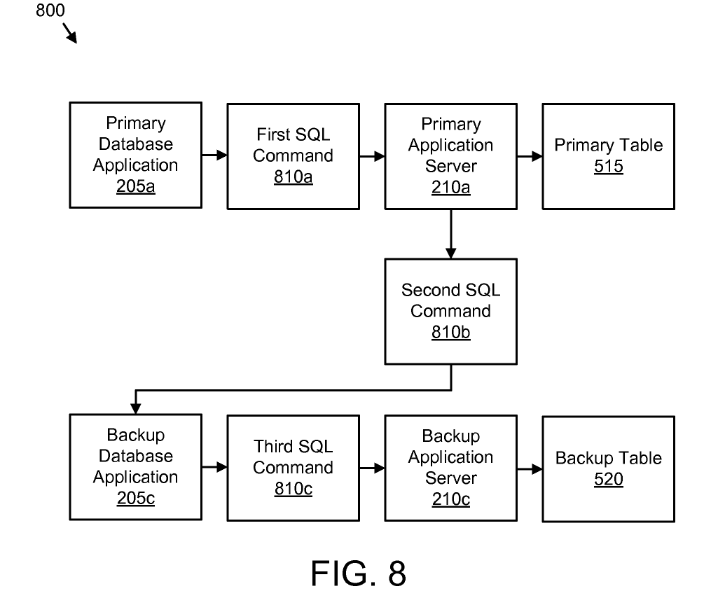

FIG. 8 is a schematic block diagram illustrating one embodiment of a synchronization process 800 of the present invention. The process 800 shows the interaction of elements and steps of FIGS. 1-7, like numbers referring to like elements and steps.

A database application of the primary data processing system 105a, hereinafter referred to as a primary database application 205a, may communicate a first SQL command 810a through an application server of the primary data processing system 105a, hereinafter referred to as a primary application server 210a. The first SQL command 810a is an update for a primary table 515 of a primary database 505.

The primary application server 210a may embody the monitor module 605 and the construction module 610. The monitor module 605 monitors 705 the first SQL command 810a and the construction module 610 constructs 710 a second SQL command 810b from the first SQL command 810a. In one embodiment, the second SQL command 810b is substantially equivalent to the first SQL command 810a.

Alternatively, the construction module 610 may modify the first SQL command 810a to accommodate differences between the primary table 515 and a backup table 520. For example, the construction module 610 may alter table names, column names, and SQL statement formats from the first SQL command 810a to the second SQL command 810b so that second SQL command 810b has an effect on the backup table 520 that is equivalent to effect of the first SQL command 810a on the primary table 515. For example, the construction module 610 may construct 710 the second SQL command 810b as using a generic SQL format.

In one embodiment, the second SQL command 810b is communicated to a database application residing on the remote data processing system 105b, hereinafter referred to as a backup database application 205c. The backup database application 205c may embody the update module 625.

The backup database application 205c applies a third SQL command 810c to the backup table 520 through an application server residing on the remote data processing system 105b, hereinafter referred to as a backup application server 210c. The third SQL command 810c may be substantially equivalent to the second SQL command 810b. Alternatively, the backup database application 205c may modify the third SQL command 810c from the second SQL command 81b. For example, the third SQL command 810c may be modified to support specific features of the backup table 520.

The backup application server 210c communicates the third SQL command 810c to the backup table 520, applying the third SQL command 810c to the backup table 520. With the application of the third SQL command 810c, the backup table 520 is synchronized with the primary table 515.

The present invention synchronizes the backup database 510 on the remote data processing system 105b with the primary database 505 on the primary data processing system 105a by monitoring 705 an update to the primary table 515 of the primary database 505, constructing 710 an SQL statement 810 from the update, and applying 720 the SQL statement 810 to the backup table 520 of the backup database 510. The present invention synchronizes the backup database 510 autonomously from and transparently to the primary database 505. In addition, the present invention allows a backup database 510 of one type to be synchronized with a primary database 505 of another type.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to synchronize a remote database, the apparatus comprising:
a monitor module configured to monitor an update from a database application to a primary table of a primary database as the update is communicated through an application server, wherein the application server is configured to manage access to the primary database by the database application;
a construction module configured to construct a Structured Query Language (SQL) command in text format that is equivalent to the update; and
an update module configured to apply the SQL command to a backup table of a backup database, wherein the backup table is a logical mirror image of the primary table prior to the application of the update to the primary table.

2. The apparatus of claim 1, further comprising a verification module configured to verify that the SQL command is successfully applied to the backup table.

3. The apparatus of claim 2, further comprising an error mitigation module configured to mitigate an unsuccessful application of the SQL command to the backup table.

4. The apparatus of claim 3, wherein the error mitigation module is configured to copy the primary table to the backup table to mitigate the unsuccessful application of the SQL command.

5. The apparatus of claim 1, wherein the construction module is further configured to aggregate a plurality of SQL commands and communicate the aggregated SQL commands as an update set.

6. A computer program product comprising a computer useable medium having a computer readable program, wherein the computer readable program when executed on a computer causes the computer to:
monitor an update from a database application to a primary table of a primary database as the update is communicated through an application server, wherein the application server is configured to manage access to the primary database by the database application;
construct a SQL command in text format that is equivalent to the update; and
apply the SQL command to a backup table of a backup database, wherein the backup table is a logical mirror image of the primary table prior to the application of the update to the primary table.

7. The computer program product of claim 6, wherein the computer readable code is further configured to cause the computer to verify that the SQL command is successfully applied to the backup table.

8. The computer program product of claim 7, wherein the computer readable code is further configured to cause the computer to mitigate an unsuccessful application of the SQL command to the backup table.

9. The computer program product of claim 8, wherein the computer readable code is further configured to cause the computer to communicate a warning to mitigate the unsuccessful application of the SQL command.

10. The computer program product of claim 8, wherein the computer readable code is further configured to cause the computer to copy the primary table to the backup table to mitigate the unsuccessful application of the SQL command.

11. The computer program product of claim 6, wherein the computer readable code is further configured to cause the computer to communicate the SQL command from a primary data processing system that comprises the primary table to a remote data processing system that comprises the backup table.

12. The computer program product of claim 11, wherein the computer readable code is further configured to cause the computer to synchronize a parameter of the primary data processing system and the remote data processing system.

13. The computer program product of claim 6, wherein the computer readable code is further configured to cause the computer to aggregate a plurality of SQL commands and communicate the aggregated SQL commands as an update set.

14. The computer program product of claim 6, wherein primary database and the backup database are of different types.

15. A system to synchronize a remote database, the system comprising:
a primary data processing system comprising
an application server configured to manage access to a primary database;
a database application configured to access the primary database through the application server;
the application server further comprising
a monitor module configured to monitor an update from the database application to a primary table of the primary database as the update is communicated through the application server;
a construction module configured to construct a SQL command in text format that is equivalent to the update;
a remote data processing system comprising
an update module configured to apply the SQL command to a backup table of a backup database, wherein the backup table is a logical mirror image of the primary table prior to the application of the update to the primary table; and
a verification module configured to verify that the SQL command is successfully applied to the backup table.

16. The system of claim 15, the remote data processing system further comprising an error mitigation module configured to mitigate an unsuccessful application of the SQL command to the backup table by copying the primary table to the backup table.

17. The system of claim 15, wherein primary database and the backup database are of different types.

18. The system of claim 15, the application server further comprising a transmitter module configured to communicate the SQL command.

19. The system of claim 18, the remote data processing system further comprising a receiver module configured to receive the SQL command from the transmitter module.

20. A method for deploying computer infrastructure, comprising integrating computer-readable code into a computing system, wherein the code in combination with the computing system is capable of performing the following:
monitoring an update from a database application to a primary table of a primary database as the update is communicated through an application server, wherein the application server is configured to manage access to the primary database by the database application;
constructing a SQL command in text format that is equivalent to the update;
applying the SQL command to a backup table of a backup database, wherein the backup table is a logical mirror image of the primary table prior to the application of the update;
verifying that the SQL command is successfully applied to the backup table; and
mitigating an unsuccessful application of the SQL command.
